(19) United States
(12) Patent Application Publication
(10) Pub. No.: US 2008/0304271 A1
(43) Pub. Date: Dec. 11, 2008

(54) Positioning structure for luminous device

(76) Inventor: Chia-Ho Lei, Taoyuan (TW)

Correspondence Address: BACON & THOMAS, PLLC, 625 SLATERS LANE, FOURTH FLOOR, ALEXANDRIA, VA, 22314-1176, US

(21) Appl. No.: 11/808,032

(22) Filed: Jun. 6, 2007

(51) Int. Cl. F21V 21/00

(52) U.S. Cl. 362/382

(57) ABSTRACT

This invention is a positining structure for luminous devices, comprising mainly of IC board, lamp and fabric. The lamp is fitted to the IC board and connected to a power supply wire, with the soft fabric either sewn or pasted on to the back of the IC board. When joining to plush toys or fabric, all that is needed is to sew the fabric on the luminous device to the surface of the fabric of the plush toy and the lamp will not move position.

### BACKGROUND OF THE INVENTION

1. Field of the Invention

This invention is a kind of luminous device positioning structure which can be sewn to plush toys or garment allowing the luminous device in the plush toy or garment to retain its position and achieve a better lighting effect.

2. Description of the Prior Art

Luminous plush toys and luminous garments seen today mostly have a lamp fitted inside or stuck to the fabric. However, vibration often causes the lamp to move position or the power supply wire to be pulled and broken, lowering the overall attractiveness of the luminous plush toy and, moreover, affecting its usability.

### SUMMARY OF THE INVENTION

The main objective of the invention is sew luminous devices inside plush toys or garments more securely, improving the lighting effect and preventing the lamp from moving or falling off.

### BRIEF DESCRIPTION OF DRAWINGS

This invention will be better understood by referring to the accompanying drawings, wherein:

FIG. 1 is an exploded perspective view of the luminous device positioning structure's bulb, IC board and fabric;

FIG. 2 is a perspective view of this invention's bulb, IC board and fabric join; and

FIG. 3 is a partial section view of this luminous device positioning structure attached to the inside of a plush toy by sewing.

### DETAILED DESCRIPTION OF THE PREFERRED EMBODIMENT

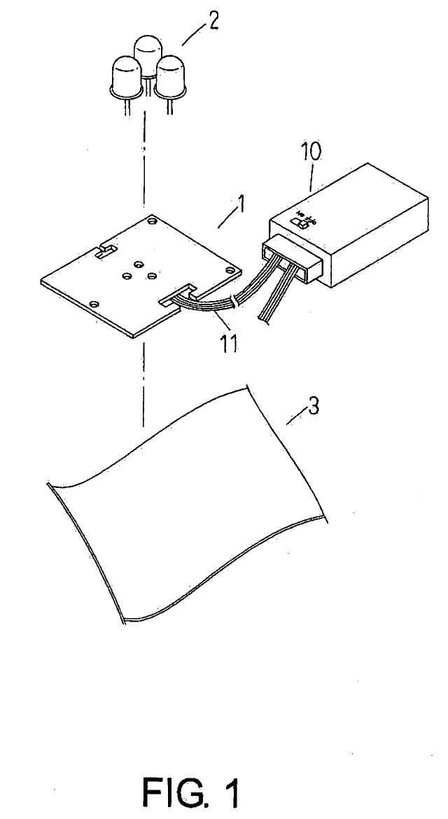

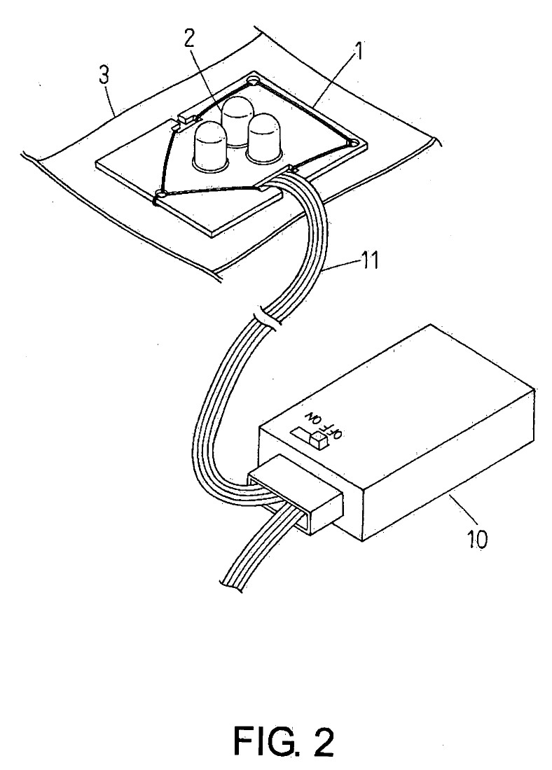

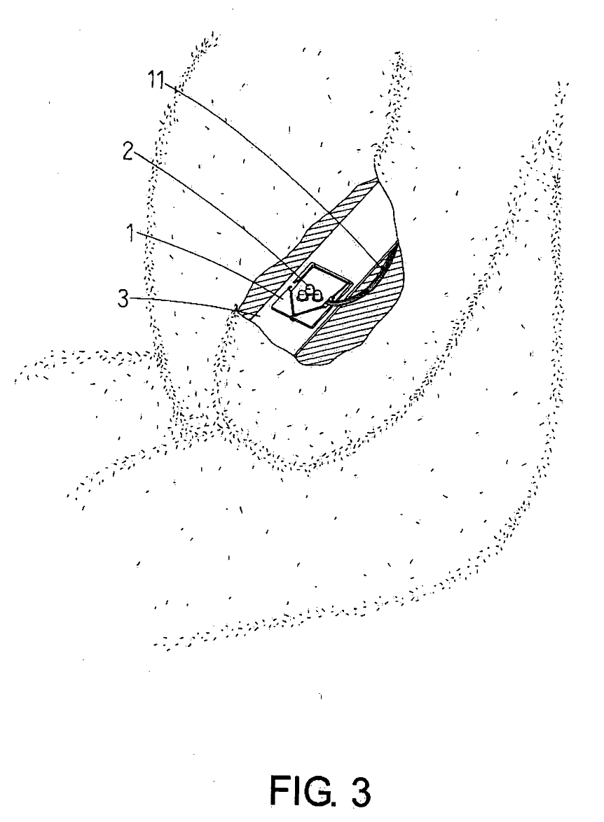

A preferred embodiment of a positioning structure for luminous devices in the present invention, as shown in FIGS. 1 to 3, includes an IC board 1, a lamp 2 and fabric 3 combined together.

IC board 1 is connected to a power supply 10 and wire. Lamp 2 is fitted on the IC board and is connected to wire 11. Lamp 2 is made of numerous LED of different colors. Fabric 3 is fitted on the bottom of IC board 1. The surface of fabric 3 is joined to IC board 1. It can be joined by sewing, nailing or pasting etc. . . .

When used all that is required is that the number of IC boards required are joined to fabric 3 in suitable places, then fabric 3 is placed in a position that plush toy A requires and secured by threading. Then the transparent fibers inside plush toy A and the different colored lamps 2 on the IC boards will interact, making the light from lamp 2 inside plush toy A brighter and more even.

When fitted inside a garment all that is required is that the fabric 3 is sewn to the inner layer of fabric of the garment, allowing the lamp to easily be attached to the inside of the garment. By then sewing up the opening in the garment lamp 2 will not easily change position or wire 11 broken a result of violent movement.

Lamp 2 that is sewn to the inner layer of fabric of the garment has an old style plaited skirt bell shaped cover which interacts with the different colored lights of lights of lamp 2 to create an even light scattering effect, making the garment more attractive.

The above explanation shows that this invention has the following advantages:

1. In this invention IC board 1, wire 11 and lamp 2 are joined together, which means wire 11 will not be pulled and broken.

2. In this invention lamp 2 is joined to plush toy A by fabric 3 on the bottom of the IC board, preventing lamp 2 inside plush toy A from moving position or light spot concentration.

3. The light produced by lamp 2 interacts with the transparent fiber inside the plush toy A, improving the light scattering effect of lamp 2.

4. In this invention IC board 1 and wire 11 are fixed to fabric 3, preventing wire 11 being pulled and broken.

While the preferred embodiment of the invention has been described above, it will be recognized and understood that various modifications may be made therein and the appended claims are intended to cover all such modifications that may fall within the spirit and scope of the invention.

I claim:

1. A positioning structure for luminous device comprising:
ic board with wires and power supply;
lamp, attached to the IC board and connected to the wire; lamp comprising of LED;
fabric, attached to the bottom of the IC board; and
said can be easily sewn into a plush toy or garment, achieving the objectives of maintaining position and even lighting.

2. A positioning structure for luminous device as claimed in claim 1, wherein said the lamp is made up of numerous LED and can thus emit bright light of different colors.

3. A positioning structure for luminous device as claimed in claim 1, wherein said the fabric and the IC board can be joined by dewing, sticking or nailing.

4. A positioning structure for luminous device as claimed in claim 1, wherein said the IC board has IC chips that allow lamp color change to be controlled.
